(19) United States
(12) Patent Application Publication
(10) Pub. No.: US 2022/0312473 A1
(43) Pub. Date: Sep. 29, 2022

(54) INFORMATION REPORTING METHOD, CONFIGURATION METHOD, MULTI-SIM TERMINAL AND BASE STATION

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/635,672

(22) PCT Filed: Aug. 15, 2019
(86) PCT No.: PCT/CN2019/100834

§ 371 Date: Feb. 15, 2022

(51) Int. Cl. H04W 74/00; H04W 74/08

(52) U.S. Cl. CPC H04W 74/004; H04W 74/0833; H04W 88/06

(57) ABSTRACT

An information reporting method including: receiving, by a multi-SIM terminal, a random access contention resolution message sent by a base station; and reporting, by the multi-SIM terminal, multi-SIM information of the multi-SIM terminal to the base station by means of a fifth message (MSG5).

### CROSS REFERENCE TO RELATED APPLICATION

The present application is a U.S. National Phase of International Patent Application Serial No. PCT/CN2019/100834 filed on Aug. 15, 2019, the entire disclosure of which is hereby incorporated by reference in its entirety for all purposes.

### BACKGROUND

With the development of wireless communication technology, an increasing number of multi-SIM terminals have emerged. Currently, the processing modes for multi-SIM terminals are depend on the implementation of various terminal manufacturers, without unified implementation standards, which leads to a plurality of different terminal behaviors and processing modes, and for multi-SIM terminals, the current networks all consider different Subscriber Identification Module (SIM) cards to be different terminals, and multiple cards of multi-SIM terminals independently transmit data with networks. In this way, when a terminal reads a paging or a measurement by using one SIM card, communications of another SIM card may be interrupted for about 20 milliseconds (ms), which, for the other SIM card, is similar to being subjected to shadowing fading, but since this situation occurs every paging cycle, this may affect power control and a link adaptation algorithm of a network, resulting in resource waste of a first system.

### SUMMARY

According to a first aspect of the disclosure, a method for information reporting is provided, applied to a multi-SIM terminal, the method including: receiving a random access contention resolution message sent by a base station; and reporting multi-SIM information of the multi-SIM terminal to the base station by a fifth message (MSG5).

According to a second aspect of the disclosure, a configuration method is provided, applied to a base station, the method including: receiving multi-SIM information of a multi-SIM terminal reported by the multi-SIM terminal; and performing related configuration for the multi-SIM terminal according to the multi-SIM information.

According to a third aspect of the disclosure, a user equipment is provided, including: a processor; and a memory for storing a processor executable instruction; the processor is configured to: receive a random access contention resolution message sent by a base station; and report multi-SIM information of the multi-SIM terminal to the base station by a fifth message (MSG5).

It should be understood that the above general description and the following detailed description are merely examples and illustrative, and cannot limit the disclosure.

### BRIEF DESCRIPTION OF THE FIGURES

The accompanying drawings herein are incorporated into the specification and constitute a part of the specification, showing examples consistent with the present invention, and are used to explain the principle of the present invention together with the specification.

FIG. 1 is a flowchart of a method for information reporting shown in an example of the present application;

FIG. 2 is a flowchart of a configuration method shown in an example of the present application;

FIG. 3 is a signaling flowchart of a configuration method shown in an example of the present application;

FIG. 4A is a block diagram of an apparatus for information reporting shown according to an example;

FIG. 4B is a block diagram of another apparatus for information reporting shown according to an example;

FIG. 4C is a block diagram of another apparatus for information reporting shown according to an example;

FIG. 5A is a block diagram of a configuration apparatus shown according to an example;

FIG. 5B is a block diagram of another configuration apparatus shown according to an example;

FIG. 6 is a block diagram of an apparatus suitable for information reporting shown according to an example; and

FIG. 7 is a block diagram of an apparatus suitable for configuration shown according to an example.

### DETAILED DESCRIPTION OF THE EXAMPLES

Examples will be described in detail here, and are shown in the accompanying drawings. When the following descriptions refer to the drawings, the same numbers in different drawings indicate the same or similar elements, unless otherwise indicated. The implementation manners described in the following examples do not represent all implementation manners consistent with the disclosure. Instead, they are merely examples of apparatuses and methods consistent with some aspects of the present invention as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

A base station may consider a relatively short interval as a problem of a wireless side, while a relatively long interval as an error case. This will lead to incorrect guidance to a control algorithm, and even lead to failure of a wireless link and trigger a corresponding recovery mechanism. Thus, autonomous behaviors of a multi-SIM terminals may disturb data statistics and related algorithms. In addition, the base station may, after the terminal is disconnected from the first system, continuously page the terminal, resulting in a waste of system resources.

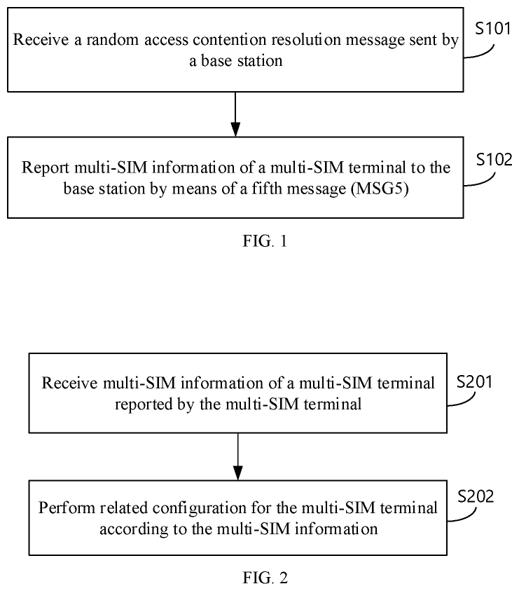

FIG. 1 is a flowchart of a method for information reporting shown in an example of the present application. This example is described from a multi-SIM terminal side; as shown in FIG. 1, the method for information reporting includes:

In step S101, a random access contention resolution message sent by a base station is received.

In this example, a multi-SIM terminal may be installed with multiple Sim cards, and the multiple SIM cards belong to different network operators.

The multi-SIM terminal may perform random access via one or multiple Subscriber Identification Module (SIM) cards, to establish RRC connection with the base station. The base station may include a 5th-Generation Communications System (5G) New Radio (NR) base station, and may also include a Fourth Generation Communications System (4G) Evolved Node B (Enb) base station. A network where the 5G NR base station is located and a network where the 4G Enb is located may belong to different network operators.

In step S102, multi-SIM information of the multi-SIM terminal is reported to the base station by means of a fifth message (MSG5).

The multi-SIM terminal may, after receiving the random access contention resolution message sent by the base station, report the multi-SIM information to the base station by means of the MSG5. The multi-SIM information includes identity information of the multiple cards such as multiple SIM cards installed in the multi-SIM terminal. The identity information may include at least one of a Serving-Temporary Mobile Subscriber Identity (S-TMSI), a random Value (randomValue), next generation 5G Serving-Temporary Mobile Subscriber Identity Part1 (ng-5G-S-TMSI-Part1), next generation 5G Serving-Temporary Mobile Subscriber Identity (ng-5G-S-TMSI) and International Mobile Subscriber Identification Number (IMSI).

The MSG5 may include a Radio Resource Control Setup Complete (RRCSetupComplete) signaling, and may also include a Radio Resource Control Connection Setup Complete (RRCConnectionSetupComplete) signaling.

When the base station accessed by the multi-SIM terminal is a 5G NR base station, the multi-SIM information of the multi-SIM terminal may be added into the RRCSetupComplete signaling, and the RRCSetupComplete signaling is reported to the base station. The multi-SIM information of the multi-SIM terminal may be added to an information unit of the RRCSetupComplete signaling, and the RRCSetupComplete signaling is reported to the base station. The multi-SIM information of the multi-SIM terminal may also be added into a dedicated Non-Access Stratum-Message (dedicatedNAS-Message) of the RRCSetupComplete signaling, and the RRCSetupComplete signaling is reported to the base station.

For example, the multi-SIM information may be carried by the following RRCSetupComplete signaling, and the carried multi-SIM information is shown in bold. The 5G NR base station may, after receiving the multi-SIM information of the multi-SIM terminal, perform related configuration for the multi-SIM terminal according to the multi-SIM information.

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |
| criticalExtensionsFuture | SEQUENCE { } |

}
}

| | |
|---|---|
| RRCSetupComplete-IEs ::= | SEQUENCE { |
| selectedPLMN-Identity | INTEGER (1..maxPLMN), |
| registeredAMF | RegisteredAMF |

OPTIONAL,

| | |
|---|---|
| guami-Type | ENUMERATED{native,mapped} |

OPTIONAL,
s-nssai-List SEQUENCE (SIZE (1..maxNrofS-NSSAI)) OF S-NSSAI OPTIONAL,

| | |
|---|---|
| dedicatedNAS-Message | DedicatedNAS-Message, |
| ue-Identity | InitialUE-Identity, |
| ng-5G-S-TMSI-Value | CHOICE { |
| ng-5G-S-TMSI | NG-5G-S-TMSI, |
| ng-5G-S-TMSI-Part2 | BIT STRING (SIZE (9)) |

}

When the base station accessed by the multi-SIM terminal is a 4G Enb base station, the multi-SIM information of the multi-SIM terminal may be added into the RRCConnectionSetupComplete signaling, and the RRCConnectionSetupComplete signaling is reported to the base station. The multi-SIM information of the multi-SIM terminal may be added to an information unit of the RRCConnectionSetupComplete signaling, and the RRCConnectionSetupComplete signaling is reported to the base station. The multi-SIM information of the multi-SIM terminal may also be added into a dedicated Information Non-Access Stratum (dedicatedInfoNAS) of the RRCConnectionSetupComplete signaling, and the RRCConnectionSetupComplete signaling is reported to the base station.

In the above example, by reporting the multi-SIM information of the multi-SIM terminal to the base station by means of the MSG5, the base station can learn that the current terminal is a multi-SIM terminal, so as to make targeted configuration for the multi-SIM terminal as early as possible.

FIG. 2 is a flowchart of a configuration method shown in an example of the present application. This example is described from a base station side; As shown in FIG. 2, the configuration method includes:

In step S201, multi-SIM information of a multi-SIM terminal reported by the multi-SIM terminal is received.

In this example, a fifth message (MSG5) sent by the multi-SIM terminal may be received, and the multi-SIM information is obtained from the MSG5.

When a current base station is a 5G NR base station, the MSG5 is a RRCSetupComplete signaling. When the current base station is a 4G Enb base station, the MSG5 is a RRCConnectionSetupComplete signaling.

When the MSG5 is a RRCSetupComplete signaling, an information unit containing the multi-SIM information in the RRCSetupComplete signaling may be parsed to obtain the multi-SIM information. A dedicatedNAS-Message in the RRCSetupComplete signaling may also be parsed to obtain the multi-SIM information.

When the MSG5 includes a RRCConnectionSetupComplete signaling, an information unit containing the multi-SIM information in the RRCConnectionSetupComplete signaling may be parsed to obtain the multi-SIM information, and a dedicatedInfoNAS may also be parsed to obtain the multi-SIM information.

The multi-SIM information includes identity information of multiple cards such as multiple SIM cards installed in the multi-SIM terminal. The identity information may include at least one of a Serving-Temporary Mobile Subscriber Identity (S-TMSI), a randomValue (randomValue), a next generation 5G Serving-Temporary Mobile Subscriber Identity Part1 (ng-5G-S-TMSI-Part1), a next generation 5G Serving-Temporary Mobile Subscriber Identity (ng-5G-S-TMSI) or an International Mobile Subscriber Identification Number (IMSI).

In step S202, related configuration is performed for the multi-SIM terminal according to the multi-SIM information.

After receiving the multi-SIM information of the multi-SIM terminal reported by the multi-SIM terminal, related configuration may be performed for the multi-SIM terminal according to the multi-SIM information. For example, a time-division multiplexing (TDM) mode may be configured for the multi-SIM terminal according to the multi-SIM information. The TDM mode is used for the multi-SIM terminal to perform operations on multiple networks belonging to multiple operators at different time periods.

In the above example, by receiving the multi-SIM information of the multi-SIM terminal reported by the multi-SIM terminal, and performing related configuration for the multi-SIM terminal according to the multi-SIM information, the base station can learn that the current terminal is a multi-SIM terminal, so as to make targeted configuration for the multi-SIM terminal as early as possible, to make correct guidance on the control algorithm and reduce waste of system resources.

FIG. 3 is a signaling flowchart of a configuration method shown in an example of the present application. This example is described from the perspective of interaction between a multi-SIM terminal and a base station, and in this example, a multi-SIM terminal initiates random access to a 5G NR base station through an SIM; as shown in FIG. 3, the configuration method includes:

In step S301, a multi-SIM terminal sends a random access preamble to a base station.

In step S302, the base station returns a random access response to the multi-SIM terminal.

In step S303, the multi-SIM terminal sends a third message (MSG3) to the base station.

In step S304, the base station sends a random access contention resolution message to the multi-SIM terminal.

In step S305, the multi-SIM terminal receives the random access contention resolution message, and reports multi-SIM information of the multi-SIM terminal to the base station through a RRCSetupComplete signaling.

In step S306, the base station receives the RRCSetupComplete signaling and obtains the multi-SIM information from the RRCSetupComplete signaling.

In step S307, the base station performs related configuration for the multi-SIM terminal according to the multi-SIM information.

In the above example, through the interaction between the multi-SIM terminal and the base station, the multi-SIM terminal can report the multi-SIM information to the base station after the random access succeeds, so that the base station can learn that the current terminal is a multi-SIM terminal, so as to make targeted configuration for the multi-SIM terminal as early as possible.

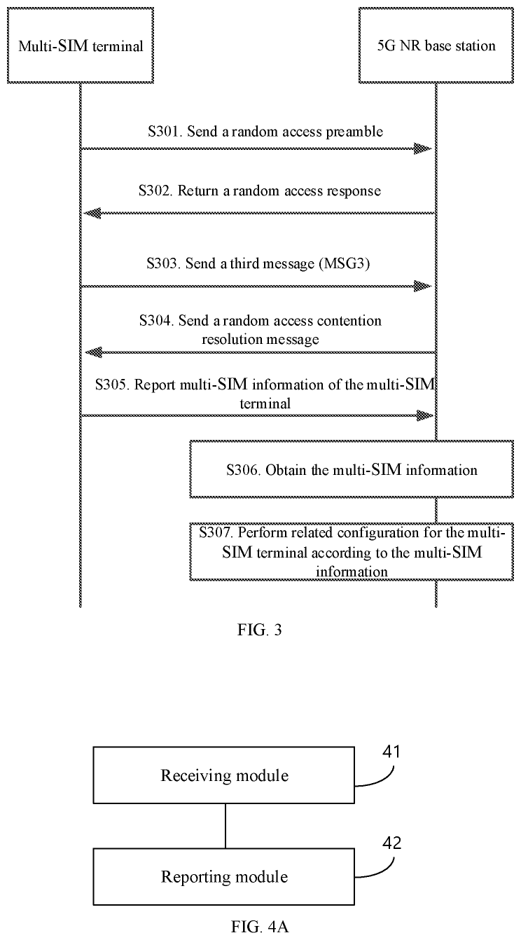

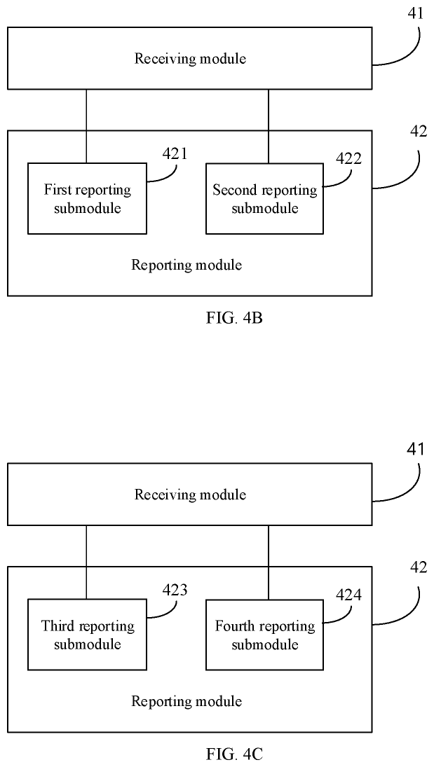

FIG. 4A is a block diagram of an apparatus for information reporting shown according to an example. The apparatus is applied to a multi-SIM terminal. As shown in FIG. 4A, the apparatus includes: a receiving module 41 and a reporting module 42.

The receiving module 41 is configured to receive a random access contention resolution message sent by a base station.

In this example, a multi-SIM terminal may be installed with multiple cards, and the multiple cards belong to different network operators.

The multi-SIM terminal may perform random access via one or multiple Subscriber Identification Module (SIM) cards, to establish RRC connection with the base station. The base station may include a 5th-Generation Communications System (5G) New Radio (NR) base station, and may also include a Fourth Generation Communications System (4G) Evolved Node B (Enb) base station. A network where the 5G NR base station is located and a network where the 4G Enb is located may belong to different network operators.

The multi-SIM terminal may, after receiving the random access contention resolution message sent by the base station, report the multi-SIM information to the base station by means of the MSG5. The multi-SIM information includes identity information of the multiple cards such as multiple SIM cards installed in the multi-SIM terminal. The identity information may include at least one of a Serving-Temporary Mobile Subscriber Identity (S-TMSI), a random Value (randomValue), next generation 5G Serving-Temporary Mobile Subscriber Identity Part1 (ng-5G-S-TMSI-Part1), next generation 5G Serving-Temporary Mobile Subscriber Identity (ng-5G-S-TMSI) or International Mobile Subscriber Identification Number (IMSI).

The MSG5 may include a Radio Resource Control Setup Complete (RRCSetupComplete) signaling, and may also include a Radio Resource Control Connection Setup Complete (RRCConnectionSetupComplete) signaling.

When the base station accessed by the multi-SIM terminal is a 5G NR base station, the multi-SIM information of the multi-SIM terminal may be added into the RRCSetupComplete signaling, and the RRCSetupComplete signaling is reported to the base station. The multi-SIM information of the multi-SIM terminal may be added to an information unit of the RRCSetupComplete signaling, and the RRCSetupComplete signaling is reported to the base station. The multi-SIM information of the multi-SIM terminal may also be added into a dedicated Non-Access Stratum-Message (dedicatedNAS-Message) of the RRCSetupComplete signaling, and the RRCSetupComplete signaling is reported to the base station.

For example, the multi-SIM information may be carried by the following RRCSetupComplete signaling, and the carried multi-SIM information is shown in bold. The 5G NR base station may, after receiving the multi-SIM information of the multi-SIM terminal, perform related configuration for the multi-SIM terminal according to the multi-SIM information.

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |
| criticalExtensionsFuture | SEQUENCE { } |

}
}

| | |
|---|---|
| RRCSetupComplete-IEs ::= | SEQUENCE { |
| selectedPLMN-Identity | INTEGER (1..maxPLMN), |
| registeredAMF | RegisteredAMF |

OPTIONAL,

| | |
|---|---|
| guami-Type | ENUMERATED{native,mapped} |

OPTIONAL,
s-nssai-List SEQUENCE (SIZE (1..maxNrofS-NSSAI)) OF S-NSSAI OPTIONAL,

| | |
|---|---|
| dedicatedNAS-Message | DedicatedNAS-Message, |
| ue-Identity | InitialUE-Identity, |
| ng-5G-S-TMSI-Value | CHOICE { |
| ng-5G-S-TMSI | NG-5G-S-TMSI, |
| ng-5G-S-TMSI-Part2 | BIT STRING (SIZE (9)) |

}

When the base station accessed by the multi-SIM terminal is a 4G Enb base station, the multi-SIM information of the multi-SIM terminal may be added into the RRCConnectionSetupComplete signaling, and the RRCConnectionSetupComplete signaling is reported to the base station. The multi-SIM information of the multi-SIM terminal may be added to an information unit of the RRCConnectionSetupComplete signaling, and the RRCConnectionSetupComplete signaling is reported to the base station. The multi-SIM information of the multi-SIM terminal may also be added into a dedicated Information Non-Access Stratum (dedicatedInfoNAS) of the RRCConnectionSetupComplete signaling, and the RRCConnectionSetupComplete signaling is reported to the base station.

In the above example, by reporting the multi-SIM information of the multi-SIM terminal to the base station by means of the MSG5, the base station can learn that the current terminal is a multi-SIM terminal, so as to make targeted configuration for the multi-SIM terminal as early as possible.

FIG. 4B is a block diagram of another apparatus for information reporting shown according to an example; as shown in FIG. 4B, based on the example shown in FIG. 4A, when the MSG5 includes the RRCSetupComplete signaling, the reporting module 42 may include: a first reporting submodule 421 or a second reporting submodule 422.

The first reporting submodule 421 is configured to add the multi-SIM information of the multi-SIM terminal into an information unit of the RRCSetupComplete signaling, and report the RRCSetupComplete signaling to the base station.

The second reporting submodule 422 is configured to add the multi-SIM information of the multi-SIM terminal into a dedicated Non-Access Stratum-Message (dedicatedNAS-Message) of the RRCSetupComplete signaling, and report the RRCSetupComplete signaling to the base station.

In the above example, by adding the multi-SIM information to an information unit of or into a dedicatedNAS-Message of the RRCSetupComplete signaling, the reporting the multi-SIM information to the base station is implemented, and the implementation means are flexible and diverse.

FIG. 4C is a block diagram of another apparatus for information reporting shown according to an example; as shown in FIG. 4C, based on the example shown in FIG. 4A, when the MSG5 includes the RRCConnectionSetupComplete signaling, the reporting module 42 may include: a third reporting submodule 423 or a fourth reporting submodule 424.

The third reporting submodule 423 is configured to add the multi-SIM information of the multi-SIM terminal into an information unit of the RRCConnectionSetupComplete signaling, and report the RRCConnectionSetupComplete signaling to the base station.

The fourth reporting submodule 424 is configured to add the multi-SIM information of the multi-SIM terminal into a dedicated Information Non-Access Stratum (dedicatedInfoNAS) of the RRCConnectionSetupComplete signaling, and report the RRCConnectionSetupComplete signaling to the base station.

In the above example, by adding the multi-SIM information to an information unit of or into a dedicatedNAS-Message of the RRCConnectionSetupComplete signaling, the reporting the multi-SIM information to the base station is implemented, and the implementation means are flexible and diverse.

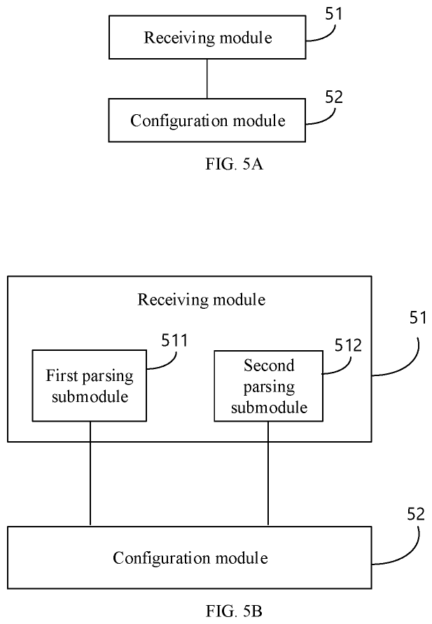

FIG. 5A is a block diagram of a configuration apparatus shown according to an example; the apparatus is applied to a base station; as shown in FIG. 5A, the apparatus includes: a receiving module 51 and a configuration module 52.

The receiving module 51 is configured to receive multi-SIM information of a multi-SIM terminal reported by the multi-SIM terminal.

In this example, a fifth message (MSG5) sent by the multi-SIM terminal may be received, and the multi-SIM information is obtained from the MSG5.

When a current base station is a 5G NR base station, the MSG5 is a RRCSetupComplete signaling. When the current base station is a 4G Enb base station, the MSG5 is a RRCConnectionSetupComplete signaling.

When the MSG5 is a RRCSetupComplete signaling, an information unit containing the multi-SIM information in the RRCSetupComplete signaling may be parsed to obtain the multi-SIM information. A dedicatedNAS-Message in the RRCSetupComplete signaling may also be parsed to obtain the multi-SIM information.

When the MSG5 includes a RRCConnectionSetupComplete signaling, an information unit containing the multi-SIM information in the RRCConnectionSetupComplete signaling may be parsed to obtain the multi-SIM information, and a dedicatedInfoNAS may also be parsed to obtain the multi-SIM information.

The multi-SIM information includes identity information of multiple cards such as multiple SIM cards installed in the multi-SIM terminal. The identity information may include at least one of a Serving-Temporary Mobile Subscriber Identity (S-TMSI), a randomValue (randomValue), a next generation 5G Serving-Temporary Mobile Subscriber Identity Part1 (ng-5G-S-TMSI-Part1), a next generation 5G Serving-Temporary Mobile Subscriber Identity (ng-5G-S-TMSI) or an International Mobile Subscriber Identification Number (IMSI).

The configuration module 52 is configured to perform related configuration for the multi-SIM terminal according to the multi-SIM information received by the receiving module 51.

After receiving the multi-SIM information of the multi-SIM terminal reported by the multi-SIM terminal, related configuration may be performed for the multi-SIM terminal according to the multi-SIM information. For example, a time-division multiplexing (TDM) mode may be configured for the multi-SIM terminal according to the multi-SIM information. The TDM mode is used for the multi-SIM terminal to perform operations on multiple networks belonging to multiple operators at different time periods.

In the above example, by receiving the multi-SIM information of the multi-SIM terminal reported by the multi-SIM terminal, and performing related configuration for the multi-SIM terminal according to the multi-SIM information, the base station can learn that the current terminal is a multi-SIM terminal, so as to make targeted configuration for the multi-SIM terminal as early as possible, to make correct guidance on the control algorithm and reduce waste of system resources.

FIG. 5B is a block diagram of another configuration apparatus shown according to an example; based on the example shown in FIG. 5A, as shown in FIG. 5B, when the MSG5 includes the RRCSetupComplete signaling, the receiving module 51 may include:

A first parsing submodule 511 is configured to parse the information unit or the dedicated Non-Access Stratum-Message (dedicatedNAS-Message) containing the multi-SIM information in the RRCSetupComplete signaling to obtain the multi-SIM information.

When the MSG5 includes the RRCConnectionSetupComplete signaling, the receiving module 51 may include:

A second parsing submodule 512 is configured to parse the information unit or the dedicated Information Non-Access Stratum (dedicatedInfoNAS) containing the multi-SIM information in the RRCConnectionSetupComplete signaling to obtain the multi-SIM information.

In the above example, by parsing the information unit or the dedicated Non-Access Stratum-Message (dedicatedNAS-Message) containing the multi-SIM information in the RRCSetupComplete signaling, the multi-SIM information is obtained, or by parsing the information unit or the dedicated Information Non-Access Stratum (dedicatedInfoNAS) containing the multi-SIM information in the RRCConnectionSetupComplete signaling, the multi-SIM information is obtained, and the implementation means are flexible and diverse.

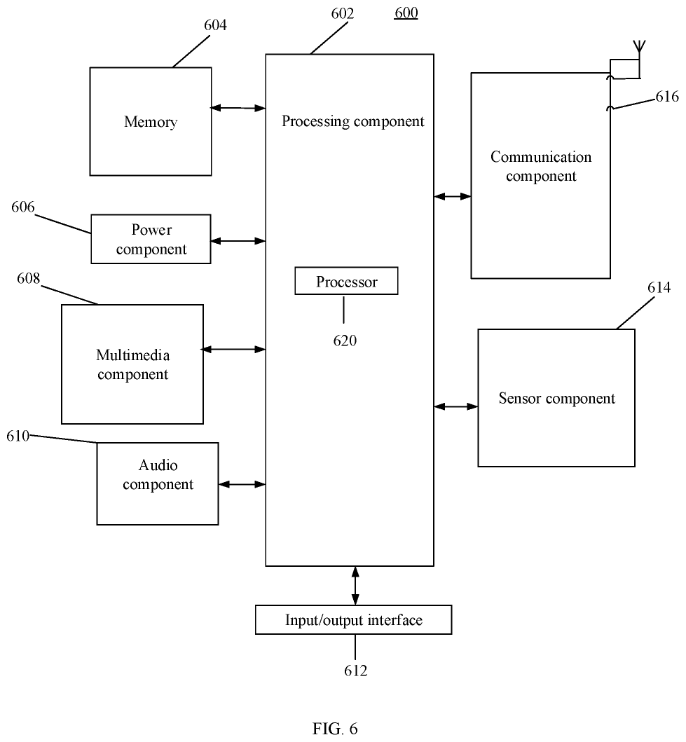

FIG. 6 is a block diagram of an apparatus suitable for information reporting shown according to an example. For example, the apparatus 600 may be user equipment such as a mobile phone, a computer, a digital broadcasting terminal, a messaging device, a game console, a tablet device, a medical device, a fitness device, or a personal digital assistant.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 usually controls the overall operations of the apparatus 600, such as operations associated with display, telephone call, data communication, camera operation and recording operation. A processing component 602 may include one or more processors 620 to execute instructions to complete all of or part of the steps of the above method.

In addition, the processing component 602 may include one or more modules to facilitate the interaction between the processing component 602 and other components. For example, a processing component 602 may include a multimedia module to facilitate interaction between the multimedia component 608 and the processing component 602.

One of the processors 620 in the processing component 602 may be configured to:

receive a random access contention resolution message sent by a base station; and

report multi-SIM information of the multi-SIM terminal to the base station by means of a fifth message (MSG5).

The memory 604 is configured to store various types of data to support the operations at the device 600. Examples of these data include instructions for any application or method operated on the apparatus 600, contact data, phone book data, messages, pictures, videos, etc. The memory 604 may be implemented by any type of volatile or non-volatile storage device or a combination of them, such as a static random access memory (SRAM), an electrically erasable programmable read-only memory (EEPROM), an erasable. programmable read-only memory (EPROM), a programmable read-only memory (PROM), a read-only memory (ROM), a magnetic memory, a flash memory, a magnetic disk or an optical disk.

The power component 606 provides power for various components of the apparatus 600. The power component 606 may include a power management system, one or more power sources, and other components associated with power generation, management and distribution of the apparatus 600.

The multimedia component 608 includes a screen for providing an output interface between the device 600 and the user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides and gestures on the touch panel. The touch sensor may sense not only the boundary of a touch or slide, but also the duration and pressure associated with the touch or slide. In some examples, the multimedia component 608 includes a front camera and/or a rear camera. When the device 600 is in an operation mode, such as a shooting mode or a video mode, the front camera and/or the rear camera may receive external multimedia data. Each front or rear camera may be a fixed optical lens system or have focal length and optical zoom capability.

The audio component 610 is configured to output and/or input audio signals. For example, the audio component 610 includes a microphone (MIC), and when the apparatus 600 is in an operation mode, such as a call mode, a recording mode and a voice recognition mode, the microphone is configured to receive external audio signals. The received audio signals may be further stored in the memory 604 or sent by the communication component 616. In some examples, the audio component 610 further includes a speaker for outputting audio signals.

The I/O interface 612 provides an interface between the processing component 602 and a peripheral interface module. The peripheral interface module may be a keyboard, a click wheel, a button, etc. The button may include but is not limited to a home button, a volume button, a start button and a lock button.

The sensor component 614 includes one or more sensors for providing various aspects of status assessment for the apparatus 600. For example, the sensor component 614 may detect an on/off state of the apparatus 600, and relative positions of components such as a display and a keypad of the apparatus 600. The sensor component 614 may also detect a position change of the apparatus 600 or one component of the apparatus 600, presence or absence of contact between the user and the apparatus 600, an orientation or acceleration/deceleration of the apparatus 600 and a temperature change of the apparatus 600. The sensor component 614 may include a proximity sensor configured to detect the presence of nearby objects without any physical contact. The sensor component 614 may also include an optical sensor, such as a CMOS or CCD image sensor, for use in imaging applications. In some examples, the sensor component 614 may also include an acceleration sensor, a gyroscope sensor, a magnetic sensor, a pressure sensor or a temperature sensor.

The communication component 616 is configured to facilitate wired or wireless communication between the apparatus 600 and other devices. The apparatus 600 may access a wireless network based on communication standards, such as WiFi, 2G or 3G, or a combination of them. In an example, a communication component 616 receives broadcast signals or broadcast associated information from an external broadcast management system via a broadcast channel. In an example, the communication component 616 further includes a near field communication (NFC) module to facilitate short range communication. For example, the NFC module may be implemented based on radio frequency identification (RFID) technology, infrared data association (IrDA) technology, ultra wide band (UWB) technology, Bluetooth (BT) technology, and other technologies.

In an example, the apparatus 600 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the above method.

In an example, a non-transitory computer-readable storage medium including instructions is further provided, such as a memory 604 including instructions executable by the processor 620 of the apparatus 600 to complete the above method. For example, the non-transitory computer-readable storage medium may be an ROM, a random access memory (RAM), a CD-ROM, a magnetic tape, a floppy disk, an optical data storage device, etc.

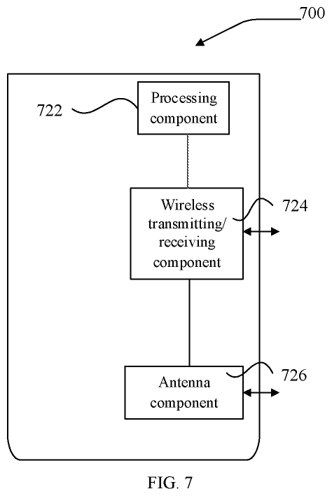

FIG. 7 is a block diagram of an apparatus suitable for configuration shown according to an example. The apparatus 700 may be provided as a base station. Referring to FIG. 7, the apparatus 700 includes a processing component 722, a wireless transmitting/receiving component 724, an antenna component 726, and a signal processing part specific to a wireless interface. The processing component 722 may further include one or more processors.

One of the processors in the processing component 722 may be configured to:

receive multi-SIM information of a multi-SIM terminal reported by the multi-SIM terminal; and

perform related configuration for the multi-SIM terminal according to the multi-SIM information.

In an example, a non-transitory computer-readable storage medium including instructions is further provided. The above instructions may be executable by the processing component 722 of the apparatus 700 to complete the above configuration method. For example, the non-transitory computer-readable storage medium may be an ROM, a random access memory (RAM), a CD-ROM, a magnetic tape, a floppy disk, an optical data storage device, etc.

The apparatus examples substantially correspond to the method examples, so reference may be made to the descriptions of the method examples. The apparatus examples described above are merely illustrative. The units as separate components may or may not be physically separated, and the components displayed as units may or may not be physical units, that is, they may be located in one place, or may be distributed to a plurality of network units. Some or all of the modules may be selected according to actual needs to achieve the objectives of the solutions of the examples. Those of ordinary skill in the art can understand and implement without any creative effort.

It should be noted that the relational terms herein such as first and second are used only to differentiate an entity or operation from another entity or operation, and do not require or imply any actual relationship or sequence between these entities or operations. The terms “include”, “comprise”, or any variants of them are intended to cover a non-exclusive inclusion, so that a process, method, article, or device that includes a series of elements not only includes those elements, but also includes other elements not listed explicitly, or includes inherent elements of the process, method, article, or device. In the absence of more limitations, an element defined by “include a . . . ” does not exclude other same elements existing in the process, method, article, or device including the element.

Those skilled in the art would readily conceive of other examples of the disclosure after considering the specification and practicing the disclosure herein. The present application is intended to cover any variations, uses or adaptive changes of the disclosure. These variations, uses or adaptive changes follow the general principle of the disclosure and include common general knowledge or conventional technical means in the technical field that are not disclosed in the disclosure.

It should be understood that the disclosure is not limited to the precise structure described above and shown in the drawings, and various modifications and changes can be made without departing from its scope. The scope of the disclosure is only limited by the appended claims.

The apparatus examples substantially correspond to the method examples, so reference may be made to the descriptions of the method examples. The apparatus examples described above are merely illustrative. The units described as separate components may or may not be physically separated, and the components displayed as units may or may not be physical units, that is, they may be located in one place, or may be distributed to a plurality of network units. Some or all of the modules may be selected according to actual needs to achieve the objectives of the solutions of the examples. Those of ordinary skill in the art can understand and implement without any creative effort.

1. A method for reporting information, the method comprising:
receiving, by a multi-SIM terminal, a random access contention resolution message sent by a base station; and
reporting, by the multi-SIM terminal, multi-SIM information of the multi-SIM terminal to the base station by a fifth message (MSG5).

2. The method according to claim 1, wherein the MSG5 comprises a Radio Resource Control Setup Complete (RRCSetupComplete) signaling or a Radio Resource Control Connection Setup Complete (RRCConnectionSetupComplete) signaling.

3. The method according to claim 1, wherein when the MSG5 comprises the RRCSetupComplete signaling, reporting multi-SIM information of the multi-SIM terminal to the base station by means of a fifth message (MSG5) comprises:
adding the multi-SIM information of the multi-SIM terminal into an information unit of the RRCSetupComplete signaling, and reporting the RRCSetupComplete signaling to the base station; or,
adding the multi-SIM information of the multi-SIM terminal into a dedicated Non-Access Stratum-Message (dedicatedNAS-Message) of the RRCSetupComplete signaling, and reporting the RRCSetupComplete signaling to the base station.

4. The method according to claim 1, wherein when the MSG5 comprises the RRCConnectionSetupComplete signaling, reporting multi-SIM information of the multi-SIM terminal to the base station by means of a fifth message (MSG5) comprises:
adding the multi-SIM information of the multi-SIM terminal into an information unit of the RRCConnectionSetupComplete signaling, and reporting the RRCConnectionSetupComplete signaling to the base station; or,
adding the multi-SIM information of the multi-SIM terminal into a dedicated Information Non-Access Stratum (dedicatedInfoNAS) of the RRCConnectionSetupComplete signaling, and reporting the RRCConnectionSetupComplete signaling to the base station.

5. The method according to claim 1, wherein the multi-SIM information comprises identity information of multiple cards installed in the multi-SIM terminal, and the identity information comprises at least one of following:
a Serving-Temporary Mobile Subscriber Identity (S-TMSI);
a randomValue (randomValue);
a next generation 5G Serving-Temporary Mobile Subscriber Identity Part1 (ng-5G-S-TMSI-Part1);
a next generation 5G Serving-Temporary Mobile Subscriber Identity (ng-5G-S-TMSI); or
an International Mobile Subscriber Identification Number (IMSI).

6. A configuration method, method comprising:
receiving, by a base station, multi-SIM information of a multi-SIM terminal reported by the multi-SIM terminal; and
performing, by the base station, related configuration for the multi-SIM terminal according to the multi-SIM information.

7. The method according to claim 6, wherein receiving multi-SIM information of a multi-SIM terminal reported by the multi-SIM terminal comprises:
receiving a fifth message (MSG5) sent by the multi-SIM terminal, and obtaining the multi-SIM information from the MSG5.

8. The method according to claim 7, wherein the MSG5 comprises a Radio Resource Control Setup Complete (RRCSetupComplete) signaling or a Radio Resource Control Connection Setup Complete (RRCConnectionSetupComplete) signaling.

9. The method according to claim 8, wherein
in response to determining that the MSG5 comprises the RRCSetupComplete signaling, obtaining the multi-SIM information from the MSG5 comprises:
parsing an information unit or a dedicated Non-Access Stratum-Message (dedicatedNAS-Message) containing the multi-SIM information in the RRCSetupComplete signaling to obtain the multi-SIM information; or,
in response to determining that the MSG5 comprises the RRCConnectionSetupComplete signaling, obtaining the multi-SIM information from the MSG5 comprises:
parsing an information unit or a dedicated Information Non-Access Stratum (dedicatedInfoNAS) containing the multi-SIM information in the RRCConnectionSetupComplete signaling to obtain the multi-SIM information.

10. The method according to claim 6, wherein performing related configuration for the multi-SIM terminal according to the multi-SIM information comprises:
configuring a time-division multiplexing (TDM) mode for the multi-SIM terminal according to the multi-SIM information, wherein the TDM mode is used-configured for the multi-SIM terminal to perform operations on multiple networks belonging to multiple operators in different time periods.

11. The method according to claim 6, wherein the multi-SIM information comprises identity information of multiple cards installed in the multi-SIM terminal, and the identity information comprises at least one of the following:
a Serving-Temporary Mobile Subscriber Identity (S-TMSI);
a randomValue (randomValue);
a next generation 5G Serving-Temporary Mobile Subscriber Identity Part1 (ng-5G-S-TMSI-Part1);
a next generation 5G Serving-Temporary Mobile Subscriber Identity (ng-5G-S-TMSI); or
an International Mobile Subscriber Identification Number (IMSI).

12-22. (canceled)

23. A user equipment, comprising:
a processor; and
a memory for storing a processor executable instruction;
the processor is configured to:
receive a random access contention resolution message sent by a base station; and
report multi-SIM information of a multi-SIM terminal to the base station by a fifth message (MSG5).

24. Abase station, comprising:
a processor; and
a memory for storing a processor executable instruction;
the processor is configured to execute the instruction to implement the configuration method according to claim 6.

25. A non-transitory computer-readable storage medium, storing computer instructions on it, wherein when the instructions are executed by a processor, the steps of the method for information reporting according to claim 1 are implemented.

26. A non-transitory computer-readable storage medium, storing computer instructions on it, wherein when the instructions are executed by a processor, the steps of the configuration method according to claim 6 are implemented.

27. The user equipment according to claim 23, wherein the MSG5 comprises a Radio Resource Control Setup Complete (RRCSetupComplete) signaling or a Radio Resource Control Connection Setup Complete (RRCConnectionSetupComplete) signaling.

28. The user equipment according to claim 23, wherein the processor is further configured to: when the MSG5 comprises the RRCSetupComplete signaling,
add the multi-SIM information of the multi-SIM terminal into an information unit of the RRCSetupComplete signaling, and report the RRCSetupComplete signaling to the base station; or
add the multi-SIM information of the multi-SIM terminal into a dedicated Non-Access Stratum-Message (dedicatedNAS-Message) of the RRCSetupComplete signaling, and report the RRCSetupComplete signaling to the base station.

29. The user equipment according to claim 23, wherein the processor is further configured to: when the MSG5 comprises the RRCConnectionSetupComplete signaling,
add the multi-SIM information of the multi-SIM terminal into an information unit of the RRCConnectionSetupComplete signaling, and report the RRCConnectionSetupComplete signaling to the base station; or
add the multi-SIM information of the multi-SIM terminal into a dedicated Information Non-Access Stratum (dedicatedInfoNAS) of the RRCConnectionSetupComplete signaling, and report the RRCConnectionSetupComplete signaling to the base station.

30. The user equipment according to claim 23, wherein the multi-SIM information comprises identity information of multiple cards installed in the multi-SIM terminal, and the identity information comprises at least one of the following:
a Serving-Temporary Mobile Subscriber Identity (S-TMSI);
a randomValue (randomValue);
a next generation 5G Serving-Temporary Mobile Subscriber Identity Part1 (ng-5G-S-TMSI-Part1);
a next generation 5G Serving-Temporary Mobile Subscriber Identity (ng-5G-S-TMSI); or
an International Mobile Subscriber Identification Number (IMSI).

31. The base station according to claim 24, wherein the processor is further configured to receive a fifth message (MSG5) sent by the multi-SIM terminal, and obtain the multi-SIM information from the MSG5.
